(19) United States
(12) Patent Application Publication
(10) Pub. No.: US 2020/0177509 A1
(43) Pub. Date: Jun. 4, 2020

(54) SYSTEM AND METHOD FOR ANYCAST LOAD BALANCING FOR DISTRIBUTION SYSTEM

(71) Applicant: Forcepoint LLC, Austin, TX (US)

(72) Inventors: Gal Itach, Ra'anana (IL); Ayval Ron, Ra'anana (IL)

(73) Assignee: Forcepoint LLC, Austin, TX (US)

(21) Appl. No.: 16/208,987

(22) Filed: Dec. 4, 2018

(51) Int. Cl. H04L 12/803; H04L 12/729; H04L 12/751; H04L 12/727; H04L 12/771; H04L 12/707; H04L 12/24

(52) U.S. Cl. CPC H04L 47/125; H04L 45/125; H04L 45/02; H04L 63/101; H04L 45/563; H04L 45/24; H04L 41/082; H04L 45/121

(57) ABSTRACT

A method for routing data packets to a distribution server, comprising generating server load data at the server using a processor. Compiling the server load data into a data update using the processor. Transmitting the data update from the server to one or more routers using a network data transmission system. Modifying a routing algorithm at the one or more routers to utilize the data update using an associated router processor.

### TECHNICAL FIELD

The present disclosure relates generally to data security, and more specifically to a system and method for anycast load balancing that eliminates bottlenecks associated with distribution processing at a dedicated central data security server.

### BACKGROUND OF THE INVENTION

Data security applications can perform content evaluation on data files, but bottlenecks can develop if a large number of users are assigned to a specific server and generate a large workload. Load balancing is difficult to apply in this context.

### SUMMARY OF THE INVENTION

A method for routing data packets to a distribution server is disclosed that includes generating server load data at the server using a processor, and compiling the server load data into a data update using the processor. The data update is then transmitted from the server to one or more routers using a network data transmission system, and a routing algorithm at the one or more routers is modified to utilize the data update using an associated router processor.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings may be to scale, but emphasis is placed upon clearly illustrating the principles of the present disclosure. Moreover, in the drawings, like reference numerals designate corresponding parts throughout the several views, and in which:

FIG. 1 is a diagram of a system for providing a distributed proxy, in accordance with an example embodiment of the present disclosure;

FIG. 2 is a flow chart of an algorithm for generating an anycast distribution processing request at an end point, in accordance with an example embodiment of the present disclosure; and

FIG. 3 is a flow chart of an algorithm for processing an anycast distribution processing request at a distributed proxy system, in accordance with an example embodiment of the present disclosure.

### DETAILED DESCRIPTION OF THE INVENTION

In the description that follows, like parts are marked throughout the specification and drawings with the same reference numerals. The drawing figures may be to scale and certain components can be shown in generalized or schematic form and identified by commercial designations in the interest of clarity and conciseness.

A client can presently send a transaction to a device that can act in the capacity of a load balancer, which will then send a new transaction to an available agent, but this creates a bottleneck, and if the device that is acting as a load balancer gets a large number of small transactions or other heavy traffic, it can cause a large number of unrelated devices that can have low traffic demands to experience excessive delays. To address this problem, IPv6 anycasting can be used to advertise one IP address from multiple points in the network topology to multiple other points. However, a dynamic routing method is required to use IPv6 anycasting to ensure that traffic is delivered to the nearest point that has sufficient processing resources to handle a specific task. Although IPv6 anycast works by having multiple receivers, only one receiver is selected from all the available ones.

IPv6 anycast is a network addressing and routing method in which incoming requests can be routed to a variety of different locations or “nodes.” In the context of a content delivery network (“CDN”), IPv6 anycast typically routes incoming traffic to the nearest data center with the capacity to process the request efficiently. Selective routing allows an IPv6 anycast network to be resilient in the face of high traffic volume, network congestion, and distributed denial of service (“DDoS”) attacks.

In order to implement a CDN using IPv6 anycast, it is necessary to change the routing algorithm to perform application-level load balancing. In order to do so effectively, shared memory with the network interface controller (“NIC”) can take place in which each distribution server provides CPU loading data, queue statistics, memory loading data and other suitable data, to allow the distribution server that can provide the fastest processing time to be selected. Unlike traditional IPv6 anycast, which seeks to select a server that is closest to an endpoint, the present disclosure is directed to selecting a server that can provide the fastest processing time.

Because distribution systems such as firewalls or proxies have a growing number of endpoints (with the highest number presently on the order to 4*10⁵ endpoint licenses), the ability to optimize distribution processing while not losing the ability to coordinate distribution learning and screening functionality is needed. Not all endpoints can send analysis requests to a certain manager/protector and therefore transactions might be delayed, causing an endpoint to wait too long for data packet processing, to experience data loss or to experience other problems.

Implementing a load balancer for a distribution system using the IPV6 anycasting allows all available content protection managers, secondary systems, content protectors, transaction analyzers and other system components to have a single IP address. When an endpoint sends a request, the least busy agent (as determined by a combination of availability, current queue statistics, CPU usage, memory usage and other suitable factors) can receive the transaction and optimize the time it takes for the endpoint to receive a response.

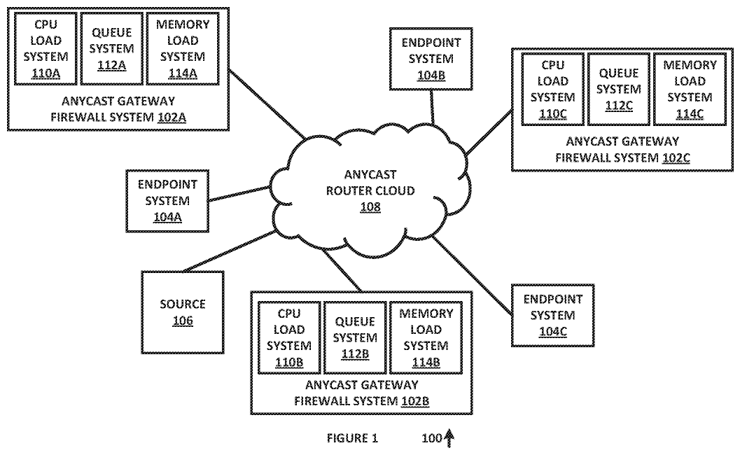

FIG. 1 is a diagram of a system 100 for providing a distributed proxy, in accordance with an example embodiment of the present disclosure. System 100 includes anycast gateway distribution systems 102A through 102C, which include CPU load systems 110A through 110C, queue systems 112A through 112C and memory load systems 114A through 114C, and further includes endpoint systems 104A through 104C, source 106 and anycast router cloud 108, each of which can be implemented in hardware or a suitable combination of hardware and software.

Anycast gateway distribution systems 102A through 102C can be implemented as one or more algorithms that cause one or more processors to perform the function of distribution screening for a request from an endpoint system 104A through 104C to a source 106, and for any responses from the source 106. Anycast gateway distribution systems 102A through 102C can include content managers, secondaries, protectors, transaction analyzers and other suitable distribution devices. In addition, anycast gateway distribution systems 102A through 102C can generate updates for each other, such as to provide real-time activity that is used to identify potential malicious activity, which could otherwise be less difficult to detect if the activity was spread out over a large number of sources and was routed to different anycast gateway distribution systems 102A through 102C. The algorithms can be implemented by converting the algorithms from a user-readable source code format to a machine readable object code format, such as by using a compiler that creates machine-readable object code that can be linked into an executable for use with a processor that has a predetermined configuration of buffers, registers, arithmetic logic units, dynamic link libraries and so forth. Anycast gateway distribution systems 102A through 102C can implemented as a number of discrete subsystems or modules, including but not limited to the subsystems and modules described herein.

CPU load systems 110A through 110C can be implemented as one or more algorithms that cause one or more processors to perform the function of generating CPU load data for an associated anycast gateway distribution system 102A through 102C. In one example embodiment, the CPU load data or other suitable data can be generated at predetermined times, based on a predetermined loading, or in other suitable manners, to allow the CPU load to be used to determine the loading on the associated anycast gateway distribution system 102A through 102C, so as to allow routing decisions to be made for optimal load distribution.

Queue systems 112A through 112C can be implemented as one or more algorithms that cause one or more processors to perform the function of generating queue size and history data for an associated anycast gateway distribution system 102A through 102C. In one example embodiment, the queue size and history data or other suitable data can be generated at predetermined times, based on predetermined queue sizes, or in other suitable manners, to allow the queue size and history to be used to determine the loading on the associated anycast gateway distribution system 102A through 102C, so as to allow routing decisions to be made for optimal load distribution.

Memory load systems 114A through 114C can be implemented as one or more algorithms that cause one or more processors to perform the function of generating memory load data for an associated anycast gateway distribution system 102A through 102C. In one example embodiment, the memory load data or other suitable data can be generated at predetermined times, based on a predetermined loading, or in other suitable manners, to allow the memory load to be used to determine the loading on the associated anycast gateway distribution system 102A through 102C, so as to allow routing decisions to be made for optimal load distribution.

Endpoint systems 104A through 104C can include one or more processors that operate algorithms that allow the processors to access source 106 or other suitable processors over a network or combination of networks. Source 106 can include one or more processors that operate algorithms that allow third parties to obtain content and/or services over the network or combination of networks. In one example embodiment, endpoint systems 104A through 104C can be distributed by anycast gateway distribution systems 102A through 102C, which can receive requests from endpoint systems 104A through 104C that will be sent to source 106, and can receive responses from source 106 that will be sent to endpoint systems 104A through 104C in response. Anycast gateway distribution systems 102A through 102C can screen the requests, the responses or other suitable data to protect endpoint systems 104A through 104C and their associated networks from malicious content.

Anycast router cloud 108 can include one or more processors that operate algorithms that allow the processors to receive data packets that are addressed to an anycast IP address, where the anycast IP address is associated with each of anycast gateway distribution systems 102A through 102C, and which selects the optimal anycast gateway distribution systems 102A through 102C to send the data packet to for analysis. Unlike prior art anycast systems that select a closest server, anycast router cloud 108 works in conjunction with anycast gateway distribution systems 102A through 102C to select the anycast gateway distribution system 102A through 102C that has the lowest latency to process the data packet, such as by analyzing CPU load data, queue data, memory load data or other suitable data of anycast gateway distribution systems 102A through 102C and determining which one of anycast gateway distribution systems 102A through 102C can process the data packet most effectively and efficiently. This selection process can result in endpoint systems 104A through 104C being assigned to an anycast gateway distribution system 102A through 102C that is not the closest, but which will nonetheless provide the fastest processing of the data packet.

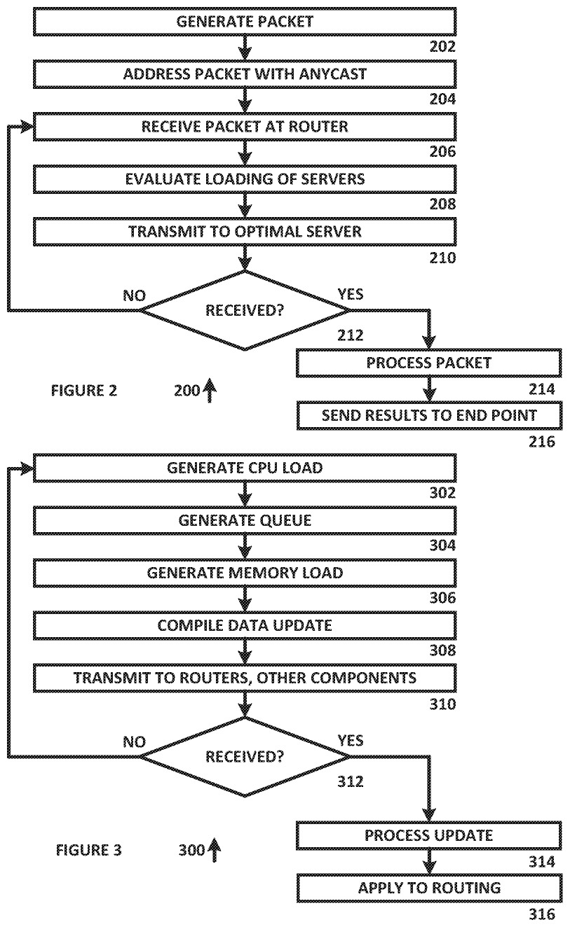

FIG. 2 is a flow chart of an algorithm 200 for generating an anycast distribution processing request at an end point, in accordance with an example embodiment of the present disclosure. Algorithm 200 can be implemented in hardware or a suitable combination of hardware and software, and can include one or more commands operating on one or more processors. While algorithm 200 and other example algorithms disclosed herein can be shown or described in flow chart form, they can also or alternatively be implemented using state machines, object-oriented programming or in other suitable manners.

Algorithm 200 begins at 202, where a packet is generated, such as by an end point or other suitable systems. The algorithm then proceeds to 204, where the packet is addressed to an anycast IP address and transmitted over a network. The algorithm then proceeds to 206, where the packet is received at an anycast router on the network, and the algorithm proceeds to 208 where the loading of two or more servers is evaluated. In one example embodiment, the CPU loading, the queue loading, the memory loading, other suitable parameters or a suitable combination of these parameters can be evaluated by a router, a server or in other suitable manners that are compliant with IPv6 anycast routing. The algorithm then proceeds to 210.

At 210, the data packet is transmitted to the server that is determined to be the optimal server, based on the evaluation of the loading. The algorithm then proceeds to 212, where it is determined whether the packet has been received. If the packet has not been received, the algorithm returns to 206, otherwise the algorithm proceeds to 214 where the packet is processed, such as to determine whether malicious code is included in the packet, whether the packet violates a network policy or for other suitable purpose. The algorithm then proceeds to 216, where the results are sent to the end point. In one example embodiment, the endpoint can receive responsive data if the packet is authorized or does not contain malware, or can receive a notice that the packet was blocked if the packet is not authorized or contains malware. Other suitable processes can also or alternatively be implemented.

FIG. 3 is a flow chart of an algorithm 300 for processing an anycast distribution processing request at a distributed proxy system, in accordance with an example embodiment of the present disclosure. Algorithm 300 can be implemented in hardware or a suitable combination of hardware and software, and can include one or more commands operating on one or more processors. While algorithm 300 and other example algorithms disclosed herein can be shown or described in flow chart form, they can also or alternatively be implemented using state machines, object-oriented programming or in other suitable manners.

Algorithm 300 begins at 302, where CPU load data is generated. In one example embodiment, the CPU load data can include instantaneous CPU load data, running average CPU load data, historical instantaneous CPU load data or other suitable load data. The algorithm then proceeds to 304.

At 304, queue data is generated. In one example embodiment, the queue data can include instantaneous queue data, running average queue data, historical instantaneous queue data or other suitable queue data. The algorithm then proceeds to 306.

At 306, memory load data is generated. In one example embodiment, the memory load data can include instantaneous memory load data, running average memory load data, historical instantaneous memory load data or other suitable memory load data. The algorithm then proceeds to 308.

At 308, update data is compiled. In one example embodiment, the update data can include the CPU load data, the queue data and/or the memory load, as well as additional data that is used by a distributed proxy system to screen malicious content, such as updated IP address blacklist or white list entries, updated malware signature data or other suitable data. The algorithm then proceeds to 310.

At 310, the data update is transmitted to one or more routers or other suitable components. In one example embodiment, the data can be transmitted periodically, in response to a predetermined event, to predetermined routers on a progressive schedule or in other suitable manners. The algorithm then proceeds to 312.

At 312, it is determined whether the data update has been received. If the data update has not been received, the algorithm returns to 302, otherwise the algorithm proceeds to 314 where the data update is processed. In one example embodiment, the data update can include a list of commands that are implemented. In another example embodiment, the data update can include one or more register entries that are processed in accordance with an algorithm at each router. The algorithm then proceeds to 316 where the data update is applied to routing of data packets. In one example embodiment, one or more routing algorithms at the router can be modified to utilize the data update, such as by adding IP addresses to white lists or black lists, adding virus signatures to a file of virus signatures or in other suitable manners.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A method for routing data packets to a server, comprising:
generating server load data at the server using a processor;
compiling the server load data into a data update using the processor;
transmitting the data update from the server to one or more routers using a network data transmission system; and
modifying a routing algorithm at the one or more routers to utilize the data update using an associated router processor.

2. The method of claim 1 wherein generating the server load data at the server using the processor comprises generating CPU load data at the server.

3. The method of claim 1 wherein generating the server load data at the server using the processor comprises generating queue data at the server.

4. The method of claim 1 wherein generating the server load data at the server using the processor comprises generating memory load data at the server.

5. The method of claim 1 further comprising generating a data update at the server using the processor that includes one or more of white list data or black list data.

6. The method of claim 1 wherein the server is a firewall server.

7. The method of claim 1 wherein the server is a proxy server.

8. The method of claim 1 further comprising:
determining whether the server load data has changed; and
updating the routing algorithm if the server load data has changed.

9. The method of claim 1 further comprising:
generating second server load data at a second server using a second processor;
compiling the second server load data into a second data update using the second processor;
transmitting the second data update from the second server to the one or more routers using the network data transmission system; and
modifying the routing algorithm at the one or more routers to utilize the data update and the second data update using an associated router processor.

10. A system for routing data packets to a server, comprising:
a server configured to generate server load data using a processor;
the server configured to compile the server load data into a data update using the processor;
the server configured to transmit the data update to one or more routers using a network data transmission system; and
the routers each configured to modify a routing algorithm to utilize the data update using an associated router processor.

11. The system of claim 10 wherein the server is configured to generate CPU load data using the processor.

12. The system of claim 10 wherein the server is configured to generate queue data using the processor.

13. The system of claim 10 wherein the server is configured to generate memory load data using the processor.

14. The system of claim 10 wherein the server is configured to generate a data update using the processor that includes one or more of white list data or black list data.

15. The system of claim 10 wherein the server is a firewall server.

16. The system of claim 10 wherein the server is a proxy server.

17. The system of claim 10 further comprising:
the routers are each configured to determine whether the server load data has changed; and
the routers are each configured to update the routing algorithm if the server load data has changed.

18. The system of claim 10 further comprising:
a second server configured to generate load data using a second processor;
the second processor configured to compile the second server load data into a second data update;
the second server configured to transmit the second data update from to the one or more routers using the network data transmission system; and
the routers configured to modify the routing algorithm to utilize the data update and the second data update using an associated router processor.
